(19) United States
(12) Patent Application Publication
(10) Pub. No.: US 2007/0232482 A1
(43) Pub. Date: Oct. 4, 2007

(54) Alumina-Coated Metal Structure and Catalyst Structure

(76) Inventors: Michael Joseph Bowe, Lancashire (GB); Clive Derek Lee-Tuffnell, Dorset (GB); David Leslie Segal, Oxfordshire (GB); Stuart Leigh Jones, Birmingham (GB)

Correspondence Address: LAW OFFICES OF WILLIAM H. HOLT, 12311 HARBOR DRIVE, WOODBRIDGE, VA, 22192, US

(21) Appl. No.: 10/566,657

(22) PCT Filed: Jul. 28, 2004
(86) PCT No.: PCT/GB04/03280

§ 371 Date: Mar. 3, 2007

(30) Foreign Application Priority Data
Aug. 1, 2003 (GB) 0318027.0

(51) Int. Cl. B01J 37/02

(52) U.S. Cl. 502/150; 502/235

(57) ABSTRACT

A metal substrate is coated with a layer of ceramic, by spraying droplets of a slurry of a ceramic precursor onto the substrate, the substrate being at a temperature between 500° C. and 750° C. The ceramic comprises alumina, and is made macroporous by spraying a mixture of alumina sol and alumina particles with no more than 35% by weight of dispersible alumina. Spraying onto a red-hot surface in this fashion leads to a very marked improvement in adhesion of the resulting ceramic to the metal substrate. A catalytically active material may then be incorporated in the ceramic layer, so as to form a catalyst structure (16).

This invention relates to a process for making a catalyst structure, and to catalytic reactors incorporating that catalyst structure.

A process is described in WO 01/51194 (Accentus plc) in which methane is reacted with steam, to generate carbon monoxide and hydrogen in a first catalytic reactor; the resulting gas mixture is then used to perform Fischer-Tropsch synthesis in a second catalytic reactor. The overall result is to convert methane to hydrocarbons of higher molecular weight, which are usually liquid or solid under ambient conditions. The two stages of the process, steam/methane reforming and Fischer-Tropsch synthesis, require different catalysts, and catalytic reactors are described for each stage. The catalytic reactors enable heat to be transferred to or from the reacting gases, respectively, as the reactions are respectively endothermic and exothermic; the heat required for steam/methane reforming is provided by gas combustion. A known catalyst for the Fischer-Tropsch synthesis utilises small particles of cobalt on a ceramic support which may be produced by dip coating a metal substrate into a slurry of a material from which the ceramic support can be made. A markedly better way of making such a catalyst has now been found.

According to the present invention there is provided a process for coating a metal substrate with a layer of ceramic suitable as a support for a Fischer-Tropsch catalyst, the method comprising forming a slurry containing dispersible alumina and particulate alumina, the particulate alumina having a particle size greater than 1 μm, and the proportion of dispersible alumina being between 5% and 35% by weight of the total alumina, and spraying droplets of the slurry onto a hot metal substrate, the substrate being at a temperature between 500° and 750° C.

Spraying onto a red-hot (or almost red-hot) surface in this fashion leads to a very marked improvement in adhesion of the resulting ceramic to the metal substrate, so that for example the substrate can be twisted without the ceramic flaking off, despite the large proportion of particulate alumina. The spray of droplets must not be so intense as to significantly cool the metal substrate, and it is desirable for the droplets to have more than 15% solid material and more preferably about 30%, so that the solid material sticks to the surface rather than being broken up by boiling solvent. Preferably the dispersible alumina is between 10% and 25% by weight of the total alumina. The dispersible alumina, which is in the form of a sol, acts as a binder to bond the particles together and to bond the particles to the surface of the metal substrate. The particulate alumina particles are porous, and the comparatively low proportion of binder ensures that the resulting ceramic layer is also porous.

Preferably the metal substrate is a steel alloy that forms an adherent surface coating of aluminium oxide when heated, for example an aluminium-bearing ferritic steel such as iron with 15% chromium, 4% aluminium, and 0.3% yttrium (eg Fecralloy™). When this metal is heated in air it forms an adherent oxide coating of alumina, which protects the alloy against further oxidation and against corrosion. The substrate may be a wire mesh or a felt sheet, which may be corrugated or pleated, but the preferred substrate is a thin metal foil for example of thickness less than 100 μm.

Such a corrugated substrate incorporating catalytic material may be inserted into a flow channel, for example defined by a groove in a plate; a catalytic reactor can consist of a stack of such plates with grooves, the plates being bonded together, and flow channels for the desired chemical reaction alternating with flow channels to provide or remove heat. Since Fischer-Tropsch synthesis is an exothermic process, then the alternating channels may carry a heat exchange fluid or coolant. The metal substrate of the catalyst structure within the flow channels enhances heat transfer and catalyst surface area.

The metal substrate may be heated in a variety of different ways, but a preferred method is to pass an electrical current through it, so that both sides of the substrate are accessible for spraying. Preferably the droplets are initially in the size range 30 to 150 μm, and they are preferably sprayed using an atomiser using cold gas. The spraying process should be carried out in such a way that rapid evaporation of the liquid occurs when the droplets impact with the foil.

A desired coating thickness of ceramic can be built up on the substrate by several successive spraying and drying steps, so that for example the final thickness of the ceramic layer may be in the range 30 to 200 μm on each side of the substrate. The ceramic will have mesopores, of characteristic size in the range 2 nm to 20 nm, which provide the majority of sites for the dispersed catalyst metal. Preferably the pores are of size between 10 and 16 nm, more preferably between 12 and 14 nm. If the droplets were to contain only alumina sol, i.e. dispersible alumina, which has a primary particle size of about 15 nm and which forms a colloidal sol in water, then the resulting ceramic would also have a mainly mesoporous character, subject to any sintering that occurs during calcination. Such a mesoporous ceramic layer would be suitable for a catalyst for reactions such as combustion or reforming. However, for catalysts such as those for use in Fischer-Tropsch synthesis it is necessary for there to be larger mesopores and also macropores, that is to say pores of size at least 50 nm and above. Such a macroporous content may be obtained by spraying droplets containing much larger alumina particles, for example γ-alumina with particles of size in the range 1 to 100 μm, preferably in the range 5-40 μm, along with some alumina sol to act as a supporting agent and as a binder. The degree of macroporosity can be controlled by changing the proportion of the particulate non-dispersible alumina to alumina sol in the mixture forming the droplets, or by changing the size of the particulate alumina particles. For example, by spraying successive layers with increasing proportions of particulate alumina, a ceramic layer can be formed in which the extent of macroporosity increases towards the outer surface of the layer.

The appropriate catalyst for the desired reaction must also be incorporated into the ceramic layer. For example noble-metal promoted cobalt is a suitable catalyst for Fischer-Tropsch synthesis. Such catalyst metals may be deposited in the form of the nitrate salt into the ceramic layer, and then heated and reduced (for example using hydrogen) to the metal. Such an approach can produce catalyst metal in a highly dispersed form consisting of very small crystallites for example of size about 10 nm, which have very high catalytic activity. Where the resulting metal crystallites would react with air, the catalyst structure may be coated with a paraffin wax, which will prevent oxidation during handling.

The invention will now be further and more particularly described, by way of example only, and with reference to the accompanying drawing:

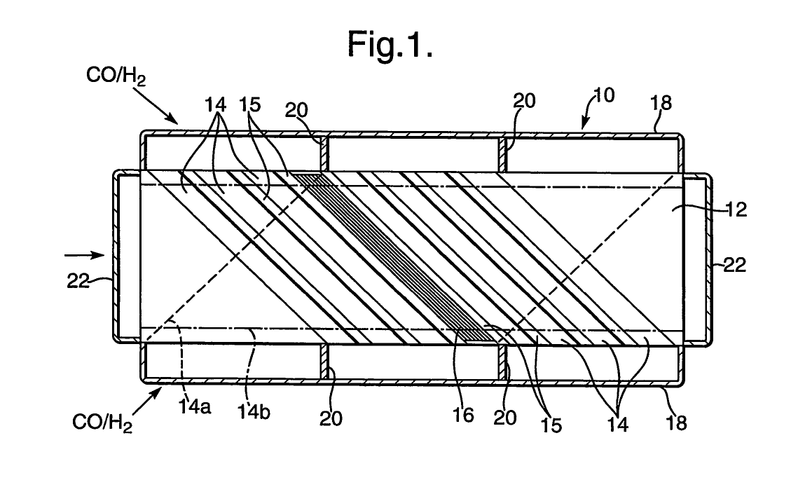

FIG. 1 shows a sectional view of a reactor suitable for performing Fischer-Tropsch synthesis, showing a plate in plan.

The invention relates to a way of making a catalyst. It particularly relates to a catalyst suitable for Fischer-Tropsch synthesis, which may form part of a process for converting methane to longer chain hydrocarbons. Fischer-Tropsch synthesis is a reaction between carbon monoxide and hydrogen, and this gas mixture may for example be generated by steam/methane reforming. In Fischer-Tropsch synthesis the gases react to generate a longer chain hydrocarbon, that is to say:
n CO+2n H₂→(CH₂)ₙ+n H₂O
which is an exothermic reaction, occurring at an elevated temperature, typically between 200 and 350° C., for example 210° C., and an elevated pressure typically between 2 MPa and 4 MPa, for example 2.1 MPa, in the presence of a catalyst such as iron, cobalt or fused magnetite, with a promoter. The exact nature of the organic compounds formed by the reaction depends on the temperature, the pressure, the flow rate, and the catalyst, as well as the ratio of carbon monoxide to hydrogen.

A preferred catalyst comprises a coating of alumina, with 10-40% (by weight compared to the weight of alumina) of cobalt, and with a ruthenium, platinum and/or gadolinium promoter, the promoter being between 0.01% to 10% of the weight of the cobalt. There may also be a basicity promoter such as ThO₂. The activity and selectivity of the catalyst depends upon the level of dispersion of cobalt metal upon the support, the optimum level of cobalt dispersion being typically in the range 0.1 to 0.2, so that between 10% and 20% of the cobalt metal atoms present are at a surface. The larger the degree of dispersion, clearly the smaller must be the cobalt metal crystallite size, and this is typically in the range 5-15 nm. Cobalt particles of such a size provide a high level of catalytic activity.

Referring now to FIG. 1 a reactor 10 for Fischer-Tropsch synthesis comprises a stack of steel plates 12, each plate being generally rectangular, 450 mm long and 150 mm wide and 3 mm thick, these dimensions being given only by way of example. On the upper surface of each such plate 12 are rectangular grooves 14 of depth 2 mm separated by lands 15 (eight such grooves being shown), but there are three different arrangements of the grooves 14. In the plate 12 shown in the drawing the grooves 14 extend diagonally at an angle of 45° to the longitudinal axis of the plate 12, from top left to bottom right as shown. In a second type of plate 12 the grooves 14a (as indicated by broken lines) follow a mirror image pattern, extending diagonally at 45° from bottom left to top right as shown. In a third type of plate 12 the grooves 14b (as indicated by chain dotted lines) extend parallel to the longitudinal axis.

The plates 12 are assembled in a stack, with each of the third type of plate 12 (with the longitudinal grooves 14b) being between a plate with diagonal grooves 14 and a plate with mirror image diagonal grooves 14a, and after assembling many plates 12 the stack is completed with a blank rectangular plate. The plates 12 are compressed together and subjected to a vacuum heat treatment to bring about diffusion bonding, so they are sealed to each other. Corrugated Fecralloy alloy foils 16 (only one is shown) 50 μm thick coated with a ceramic coating containing a catalyst material, of appropriate shapes and with corrugations 2 mm high, can be slid into each such diagonal groove 14 or 14a.

Header chambers 18 are welded to the stack along each side, each header 18 defining three compartments by virtue of two fins 20 that are also welded to the stack. The fins 20 are one third of the way along the length of the stack from each end, and coincide with a land 15 (or a portion of the plates with no groove) in each plate 12 with diagonal grooves 14 or 14a. Coolant headers 22 in the form of rectangular caps are welded onto the stack at each end, communicating with the longitudinal grooves 14b. In a modification (not shown), in place of each three-compartment header 18 there might instead be three adjacent header chambers, each being a rectangular cap like the headers 22.

In use of the reactor 10 the mixture of carbon monoxide and hydrogen is supplied to the compartments of both headers 18 at one end (the left hand end as shown) of the stack, and so gases produced by Fischer-Tropsch synthesis emerge through the compartments of both headers 18 at the right hand end as shown. The flow path for the mixture supplied to the top-left header compartment (as shown), for example, is through the diagonal grooves 14 into the bottom-middle header compartment, and then to flow through the diagonal grooves 14a in other plates in the stack into the top-right header compartment. A coolant is supplied to the header 22 at the same end of the stack, to maintain the temperature within the reactor 10 at about 210° C., so that the coolant is at its lowest temperature at the area where heat generation is at its maximum during the first stage. Hence the flows of the reacting gases and the coolant are at least partially co-current. The intention is to approach isothermal conditions throughout the reactor 10; this has the advantage of minimising the risk of any wax (i.e. very long chain hydrocarbon) blocking the flow channels towards the outlet from the reaction channels. The flow rate (space velocity) of the reacting gases is in the range 1000-15000/hr, so as to ensure that the conversion of carbon monoxide is only about 60% by the time the gases leave the reactor 10, so that the water vapour does not exceed 20 mole % (and its partial pressure does not exceed 0.4 MPa).

The catalyst-carrying foils 16 are produced as follows. A colloidal sol is made by combining water-dispersible alumina with water, the alumina having a primary particle size of about 15 nm that form agglomerates of size about 110 nm; the specific surface area may be in the range 110-350 m²/g. This requires high shear mixing to ensure uniformity. The pH of the sol is adjusted with ammonium hydroxide to lie in the range pH 8.5-12.5, preferably pH 8.5-9.5. This sol is mixed with particulate γ-alumina stabilised with 3% lanthanum oxide, this non-dispersible alumina having a mean particle size about 10 μm, with pores of size 5-20 nm, and a specific surface area in the range 110-350 m²/g. The proportions are preferably such that the sol alumina is between 3 and 10% by weight of the resulting mixture, more preferably between 3 and 5%, and that the particulate alumina is between 12 and 35% by weight of the resulting mixture. For example the sol alumina may be 3% and the particulate alumina 27% by weight of the mixture (so that the sol alumina is 10% of the total alumina). This mixture is thoroughly blended to form a slurry or suspension and again the pH is adjusted to about pH 8.7 by adding dilute ammonia.

At this stage the viscosity of the suspension may be monitored to ensure consistency, and to ensure that the viscosity is in the optimum range for spraying. If the viscosity is too low, the particulate alumina will fall out of suspension and will clog the spray gun, while if the viscosity is too high, it will not readily pass through the nozzle of the spray gun. The suspension is thixotropic, but measurements can be made for example using a dial viscometer operating at a rotational speed of 6 RPM; preferably the mean viscosity is between 13 and 14 Pa s (13,000-14,000 centipoise).

A corrugated Fecralloy foil is heated to 550° C., and is held at this temperature, for example being clipped onto a heated block, and the suspension of alumina is sprayed onto the foil, the droplets typically having a mean size in the range 30 μm to 150 μm. For example this may use an atomiser using cold gas. Rapid evaporation of the water occurs as the droplets impact with the foil, and a strong bond is formed between the alumina from the droplets and the oxide on the surface of the foil. This rapid evaporation ensures that there is no tendency for the suspension to flow over the surface to form pools in the bottoms of corrugations. The ceramic layer is built up by several successive spraying steps, to achieve a thickness typically between 50 and 200 μm, for example 100 μm, on each side of the foil. The spray should evenly wet the surface of the foil, and the coating should be just wet enough to see the water flash off from the suspension. The coating changes from white to grey as the water evaporates, in about a second or less, and it is important to ensure that each coat is dry before the next coating is applied. Substantial uniformity of the thickness is ensured by changing the arc of the spray head so that all the surfaces receive a similar mass of droplets. The thickness of the coating may be monitored by weighing the foil at intervals during the spraying process.

It will be appreciated that the way in which the droplets are formed is not critical to the invention, and that they might alternatively be made by other processes, such as ultrasonic spraying or electrostatic spraying. It will also be understood that the particulate alumina might have a different mean particle size, say between say 1 μm and 40 μm, more preferably in the range 1 μm to 20 μm for example 5 μm or 10 μm. Such smaller particulate material is somewhat easier to spray and to form a uniform ceramic layer with good adhesion to the metal substrate. The size of the mesopores in the resulting ceramic layer is preferably 12-14 nm for Fischer-Tropsch catalysts; depending on the type of particulate alumina used to form the slurry, it may be necessary provide a subsequent calcining step to ensure this mesopore size. For example, if the particulate alumina is made by the hydrolysis and peptisation of an alkoxide, the typical pore diameter would be 8-10 nm, and the desired larger pores can be formed by calcining at about 700° C., either before the particulate alumina is used to make the slurry, or after the ceramic coating has been deposited on the metal substrate. Alternatively, if the particulate alumina is initially in the boehmite form, then it forms γ-alumina with pores of the correct size on heating to above about 480° C., either during the spraying or subsequent calcination/dehydroxylation step.

Preferably the ceramic layer has a macropore volume of 0.5 ml/g, for Fischer-Tropsch catalysis. It is also desirable for the macroporosity to be greater nearer the exposed surface to facilitate egress of liquid product. This can be achieved by making alumina suspensions containing different proportions of dispersible (sol) and non-dispersible (particulate) alumina. For example the first sprayed suspension might contain 4% (by weight) sol alumina and 12% particulate alumina; the next suspension might contain 3% sol alumina and 12% particulate alumina; the next suspension 3% sol alumina and 17% particulate alumina; and a final suspension of 3% sol alumina and 27% particulate alumina. The proportion of alumina in the form of sol (which acts as a binder) would thus progressively decrease from 25% to 10% in the successively sprayed suspensions, but in each case alumina forms at least 15% by weight of the suspension.

The ceramic layer is then calcined/dehydroxylated using a slow temperature ramp (e.g. 1° C./min) from room temperature up to 550° C. and held for four hours, before being cooled; the temperature may be held at intermediate values such as 80° C. and 150° C. for say one hour during this temperature ramp. (As mentioned above, depending on the type of particulate alumina, it may be necessary for this calcination step to proceed up to 700° C. in order to ensure the mesopores have the desired 12-14 nm size.) It is then sprayed with hydrated cobalt nitrate dissolved in acetone (which has a low surface tension and a low viscosity), or in a mixture of acetone and water, and then heat treated and reduced at elevated temperature in the presence of hydrogen. Instead of spraying, the cobalt solution may be applied by a non-aqueous incipient wetness procedure. The promoter may be impregnated along with the cobalt. The reduction forms cobalt metal crystallites in the range 5-15 nm, which provide a high level of catalytic activity. The surface is then coated with paraffin wax to protect it from air. The corrugated foil 16 with the catalyst coating can then be inserted into the reactor as described in relation to FIG. 1. Heating the reactor to its operating temperature melts the wax, which is then carried out of the reactor by the gas flow.

The preferred process for forming cobalt crystallites, after spraying the ceramic layer with the solution containing cobalt nitrate is as follows. Firstly the ceramic is dried and then calcined, to ensure that the cobalt is in the form of cobalt oxide, Co₃O₄, this process being carried out in air at temperatures up to say 250° C. This spraying, drying and calcining may be repeated to increase the quantity of cobalt present in the ceramic. It is then reduced, for example using hydrogen gas, gradually increasing the temperature to a value above that at which the transition from CoO to Co metal occurs (as observed for example from a differential thermogravimetric profile), and held at this elevated temperature for a prolonged time. This process generates cobalt crystallites of size 12-14 nm. Preferably the cobalt is then subjected to a gentle oxidation process, and then subjected to a further reduction process similar to that previously followed; this appears to change the form, if not the size, of the crystallites, with a consequential improvement in activity.

Although the method has been described in the context of making a Fischer-Tropsch catalyst, it will be appreciated that it may be used for other catalysts. It is particularly beneficial where significant macroporosity or graded porosity is required.

It will be appreciated that the process described above is given by way of example only. For example the temperature of the foil during the spraying process may be held at a different temperature (within the range 500° C. up to 750° C.), and the foil may be heated by a different method, such as direct electrical heating. For a Fischer-Tropsch catalyst the stability of the alumina is an important consideration, in particular the avoidance of the reaction between alumina and cobalt in the presence of water to form cobalt aluminate. This may be suppressed by carrying out the reaction in such a way that the water vapour concentration remains low, but the particulate alumina preferably incorporates a stabiliser such as the lanthanum oxide mentioned above or an alternative stabiliser such as zirconia.

1. A process for coating a metal substrate with a layer of ceramic suitable as a support for a Fischer-Tropach catalyst, the method comprising forming a slurry containing dispersible alumina and particulate alumina, the particulate alumina having a particle size greater than 1 μm, and the proportion of dispersible alumina being between 5% and 35% by weight of the total alumina, adjusting the pH of the slurry so the slurry in of high viscosity, and spraying droplets of the slurry onto a hot metal substrate, the substrate being at a temperature between 500° and 750° C.

2. A process as claimed in claim 1 wherein the droplets comprise at least 15% solid material.

3. A process as claimed in claim 1 wherein the metal substrate comprises an aluminium-bearing ferritic steel.

4. A process as claimed in claim 1 wherein the ceramic layer also incorporates a stabiliser.

5. A process as claimed in claim 1 wherein the coated substrate is subsequently calcined.

6. A process as claimed in claim 1 wherein the layer is built up by successively spraying droplets of slurries of different compositions.

7. A process as claimed in claim 6 wherein the compositions are such that the layer increases in porosity towards its exposed surface.

8. A process of making a catalyst, comprising coating a metal substrate with a layer of porous ceramic by a process as claimed in claim 1, and incorporating catalyst material into the ceramic layer.

9. A process as claimed in claim 8 wherein the catalyst material is a catalytic metal, and the catalytic metal is incorporated by contacting the ceramic layer with a solution of a salt of the metal in a solvent comprising an organic liquid whose surface tension and viscosity are lower than those of water.

10. A process as claimed in claim 8 wherein the ceramic layer incorporates a catalytic metal, and is then coated with wax to protect it from the atmosphere.

11. A catalyst made by a process as claimed in claim 8.

12. A process as claimed in claim 8 wherein the catalyst material is a catalytic metal, and the catalytic metal is incorporated by contacting the ceramic layer with a solution of a salt of the metal, drying and then calcining the ceramic layer to convert the metal into an oxide, and then repeating the contacting, drying and calcining steps to increase the quantity of the catalytic metal present in the ceramic layer.
